(19) United States
(12) Patent Application Publication
(10) Pub. No.: US 2019/0176407 A1
(43) Pub. Date: Jun. 13, 2019

(54) SEGMENTED COMPOSITE TUBE ASSEMBLY WITH SCARF JOINTS

(71) Applicant: Bell Helicopter Textron Inc., Fort Worth, TX (US)

(72) Inventor: Olivier Blanc, Quebec (CA)

(21) Appl. No.: 15/834,386

(22) Filed: Dec. 7, 2017

(51) Int. Cl. B29C 65/00; B29C 65/70; B29C 70/46; B29C 70/44

(52) U.S. Cl. CPC B29C 66/4329; B29C 65/70; B29L 2031/3076; B29C 70/44; B29C 70/465

(57) ABSTRACT

A hollow tube assembly is constructed from two or more concave segments, each having longitudinal edges that are tapered perpendicular to the longitudinal direction of the assembly with substantially identical tapers. The respective tapered edges are joined at respective joining faces forming scarf joints, either with or without applying an adhesive between opposing joining faces. The overall thickness of the scarf joint may substantially correspond to the thickness of the segments. The scarf joints may be straight or arcuate. The segments may be constructed by overlaying layers of a composite material made of carbon fiber reinforced polymers and may be provided in pre-impregnated (prepreg) form.

### TECHNICAL FIELD

This disclosure relates to a tube assembly that is manufactured from a plurality of segments that are joined by scarf joints.

### BACKGROUND

Airframes, such as rotorcraft airframes, typically include various components, such as spars, beams, frames or stiffeners, designed to carry structural loads. More particularly, such components may be long and slender, mostly straight along their length, with a hollow cross-section. Examples are tail booms and horizontal stabilizer spars. While these components have in the past been constructed of aluminum or other light-weight metals, they are more recently increasingly constructed from composite materials. These composite materials may be any type of composite, such as carbon fiber reinforced polymer (CFRP), any combination of structural fibers (Kevlar®, glass, carbon, basalt, Dyneema®, etc.) and any plastic resin system (polyester, epoxy, bismaleimide (BMI) plastics, etc.).

Materials can be in the form of prepreg, or dry fibers impregnated with a liquid resin. Fibers can be either woven fabric or have a unidirectional construction. Prepreg is a common term for fabric reinforcement that has been pre-impregnated with a resin system. The resin system is typically an epoxy and already includes the proper curing agent. As a result, it is ready to be placed into a mold without further addition of resin or performance of the steps required for a typical hand lay-up.

Prepreg components may be stored at room temperature and offer a number of specific advantages, including near-perfect epoxy resin content, maximizing strength properties for the reinforcement, and excellent surface finish in that they are engineered to be less porous at the surface, making them easier to keep and handle. Prepreg components can be heat-cured in a mold to form the desired finished product. After the necessary heating cycle for curing is complete, the prepreg components or finished parts are ready for service without additional waiting time.

Composite parts with a hollow cross-section have in the past been prepared by wrapping a one-piece layup around a male mandrel and then transferring the hollow layup inside a closed tool for curing. An airtight bladder, balloon or bag can then be placed inside the hollow layup and inflated, for example, by injecting compressed air therein. This presses the layup against the inside of the closed tool. However, accurate and perfect contact between the outside surfaces of the layup and the inside surfaces of the mold is difficult to obtain, resulting in frequently unacceptable defects such as fiber pinching, voids and wrinkles.

It would therefore be desirable and advantageous to provide a composite tube assembly with a hollow cross-section, in particular for an aircraft component, which obviates the aforedescribed shortcomings and can be fabricated without the aforementioned defects and without impairing the dimensional integrity and mechanical strength of the tube assembly.

### SUMMARY

This disclosure relates generally to the fabrication of composite tube assemblies with a hollow cross-section of a type that can be used, for example, in horizontal stabilizers of a rotorcraft.

One innovative aspect of the subject matter described herein can be implemented as a hollow tube assembly composed a plurality of concave segments extending in a longitudinal direction of the assembly and having tapered edges, wherein different of the plurality of segments are joined along the tapered edges by respective scarf joints to form the hollow tube assembly.

This, and other aspects, may include one or more of the following features. The scarf joint may have an overall thickness that is substantially equal to a thickness of the concave segments. The tapered edges may have a taper angle of less than about 6 degrees, preferably less than 3 degrees, but larger angles may be used, provided that structural loads can still be carried. The concave segments may be constructed from a layered composite material made of structural fibers in combination with a plastic resin, such as carbon fiber reinforced polymers (CFRP). The composite material may be pre-impregnated with resin (prepreg). In order to form the scarf joint, the resin-impregnated CFRP layers may be superimposed with a relative offset perpendicular to the longitudinal direction. The scarf joints may be formed with or without application of an interposed adhesive. The scarf joints may have a substantially straight or an arcuate shape.

Another innovative aspect of the subject matter described herein relates to a method for forming a hollow tube assembly from a plurality of concave segments extending in a longitudinal direction of the assembly. Initially, at least one first segment having first tapered edges with a first taper perpendicular to the longitudinal direction and at least one second segment having second tapered edges with a second taper perpendicular to the longitudinal direction are prepared. The respective first and second concave segments are then joined along the respective first and second tapered edges by a scarf joint.

The first and the second concave segment may be joined by placing the respective concave segments inside a mold and urging the outer sides of the concave segments against inside surfaces of the mold. The joined segments may be cured at elevated temperatures. Before curing, the tapered edges of the first and second segments are still malleable and therefore capable of moving against one another inside the mold.

The details of one or more implementations of the subject matter described in this disclosure are set forth in the accompanying drawings and the description below. Other features, aspects, and advantages of the subject matter will become apparent from the description, the drawings, and the claims.

A further innovative aspect of the subject matter described herein relates to an airframe component constructed to carry structural loads, which includes a hollow tube assembly constructed from a plurality of concave segments made of a layered fiber-reinforced composite material, with the concave segments extending in a longitudinal direction of the assembly and having tapered edges, wherein different of the plurality of concave segments are joined along the tapered edges by respective scarf joints having a scarf angle of less than 6 degrees

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates an example rotorcraft in accordance with certain embodiments;

FIG. 2 illustrates an example scarf repair of a damaged laminate under a tensile load;

FIG. 3 illustrates an example scarf joint between two laminates under a bending load;

FIG. 4 illustrates an example temperature profile of a temperature cycle for curing the base laminate and the repair patch;

FIG. 5A illustrates the stiffness of a scarf joint joining two laminates as a function of the scarf angle under a bending load;

FIG. 5B illustrates the maximum load to failure of a scarf joint joining two laminates as a function of the scarf angle under a bending load;

FIG. 6 illustrates an example clam shell tool used for curing the segmented composite tube assembly;

FIG. 7 illustrates a segmented composite tube assembly in cross-section in a first exemplary embodiment;

FIG. 8 illustrates a segmented composite tube assembly in cross-section in a second exemplary embodiment;

FIG. 9 illustrates a segmented composite tube assembly in cross-section in a third exemplary embodiment;

FIG. 10 illustrates a segmented composite tube assembly in cross-section in a fourth exemplary embodiment;

FIG. 11 illustrates a segmented composite tube assembly in cross-section in a fifth exemplary embodiment; and

FIG. 12 illustrates a segmented composite tube assembly in cross-section in a sixth exemplary embodiment.

### DETAILED DESCRIPTION

The following disclosure describes various illustrative embodiments and examples for implementing the features and functionality of the present disclosure. While particular parts, components, assemblies, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming, it would nevertheless be a routine undertaking for those of ordinary skill in the art having the benefit of this disclosure.

In this specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “spaced-apart,” “inwardly,” “outwardly” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction.

Furthermore, the present disclosure may repeat reference numerals and/or letters in the various examples. This repetition is for the purpose of simplicity and clarity and does not in itself dictate a relationship between the various embodiments and/or configurations discussed.

Example embodiments that may be used to implement the features and functionality of this disclosure will now be described with more particular reference to the attached FIGURES.

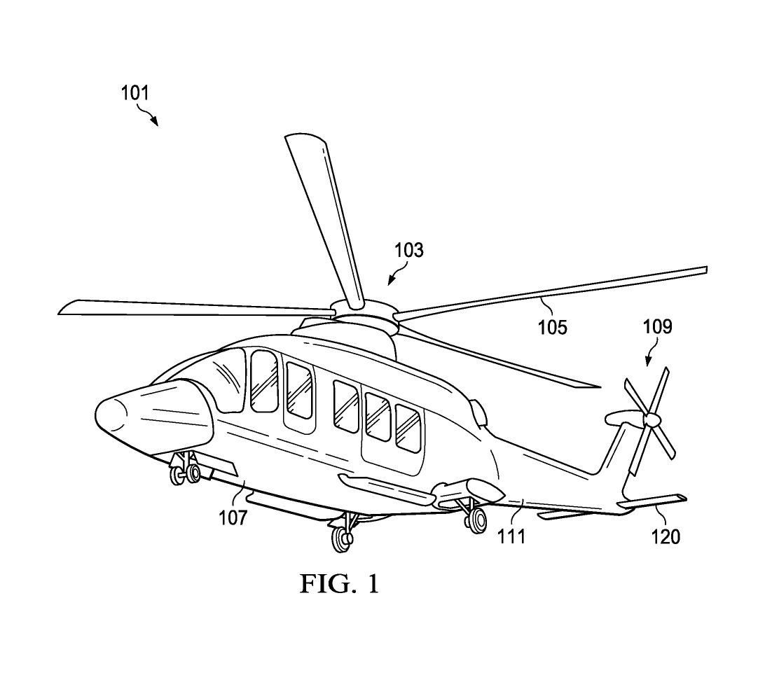

FIG. 1 illustrates an example embodiment of a rotorcraft 101. The illustrated example portrays a perspective view of the rotorcraft 101. Rotorcraft 101 includes a rotor system 103 with a plurality of rotor blades 105. The pitch of each rotor blade 105 can be managed or adjusted in order to selectively control direction, thrust, and lift of rotorcraft 101. Rotorcraft 101 further includes a fuselage 107, and a tail structure 111 with an empennage 109 that includes a tail rotor or anti-torque system. In the illustrated embodiment, the tail structure 111 may also include a horizontal stabilizer or spar 120. Torque is supplied to rotor system 103 and to the anti-torque system using at least one engine. The horizontal stabilizer or spar 120 is typically constructed in one or more longitudinal sections, for example, in form of an elongated hollow (tubular) structure (spar). The spar should be light-weight and resist torsion and bending forces. Carbon fiber reinforced polymer (CFRP) has recently increasingly replaced light-weight metals, such as aluminum, in the construction of aircraft components, such as the aforementioned tubular structure.

It should be appreciated that the depicted rotorcraft 101 of FIG. 1 is merely illustrative of a variety of aircraft that can be used to implement embodiments of the present disclosure. Other aircraft implementations can include, for example, fixed wing airplanes, hybrid aircraft, tiltrotor aircrafts, unmanned aircraft, gyrocopters, a variety of helicopter configurations, and drones, among other examples. Moreover, it should be appreciated that even though aircraft are particularly well suited to implement embodiments of the present disclosure, the described embodiments can also be implemented using non-aircraft vehicles and devices.

Composite parts made by the process described in this disclosure are typically long and slender, mostly straight along their length, with a hollow cross-section. These are typically spars, beams, frames or stiffeners, designed to carry structural loads in airframes.

While conventional plastic tubular components may be fabricated, for example, by injection molding, such process is not feasible for parts with a hollow cross section made from carbon-fiber reinforced laminates. Such parts are typically made by successively overlaying layers of a carbon-fiber fabric that may be pre-impregnated with a thermo-curable resin, also referred to as prepreg, over a mandrel until the desired thickness of the part is reached. The so prepared part is then inserted into an autoclave and cured at elevated pressure and temperature.

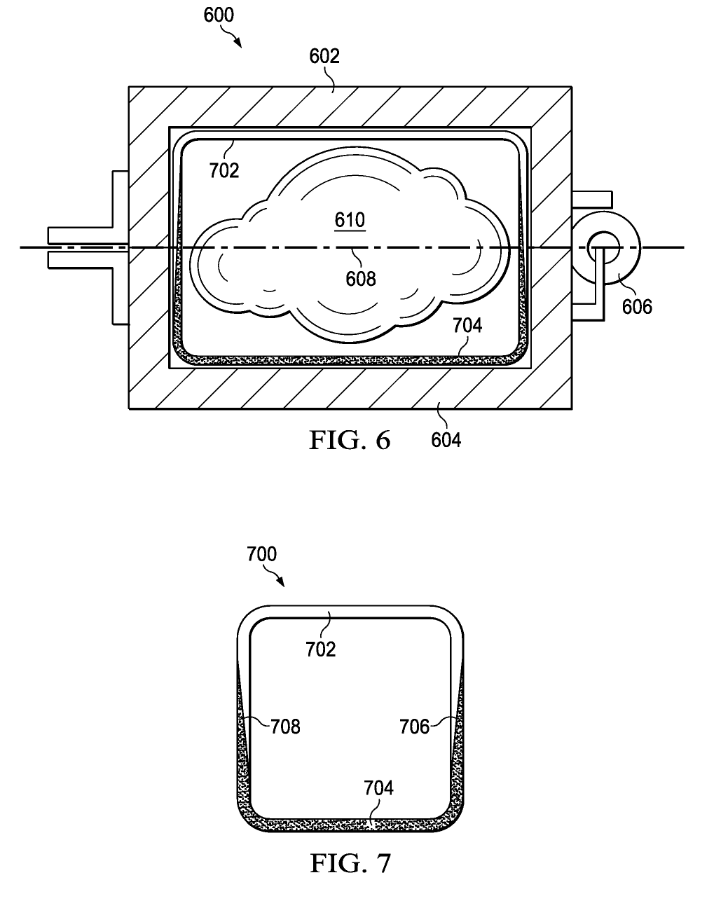

During the curing process, the dimensional stability and the outside dimensions and smoothness of the part cannot be ensured unless it is placed inside a mold, such as the clamshell mold schematically illustrated in FIG. 6. An inflatable and deformable bladder 610 may be placed inside the hollow part and thereafter inflated to urge the outside surfaces of the part against the inside of the mold during curing. However, the fit of the part inside the mold may be imperfect, thus potentially leaving void and creases on the surface of the part after curing.

To ensure the dimensional stability and the outside dimensions and smoothness of the part, the present disclosure proposes to split the finished part along its longitudinal direction in a minimum of two separate segments to allow the composite material to deploy and conform to the inside surface of the closed curing tool in response to an internal pressure exerted, for example, by an inserted bladder 610 during the curing process.

The at least two segments may be joined by scarf joints wherein respective ends of the segments are tapered with a slope ratio of typically between a minimum of 10:1 and a maximum of 50:1. Exemplary scarf joints are illustrated in FIG. 7 through FIG. 12 and their construction and method of manufacturing will be described in more detail below.

A scarf joint is a method of joining two members end to end and is widely known in woodworking or metalworking. The scarf joint is primarily used when the material being joined is not available in the length required. It is an alternative to other joints such as the butt joint and the splice joint and is often favored over these other joints because it yields a barely visible joint line.

The use of modern high-strength adhesives can greatly increase the structural performance of a plain scarf joint. Traditionally, a scarf joint is formed by cutting opposing tapered ends on each member which are then fitted together. The ends of a plain scarf are feathered to a fine point which aids in the obscuring of the joint in the finished work. At a shallow enough angle, strength of the joint continues to increase with decreasing scarf angle, and failure can occur anywhere in the two pieces, possibly even outside the joint.

More recently, composite laminates, in particular carbon-fiber reinforced laminates, have gained wide acceptance in airframe manufacturing due to their lower weight than aluminum and their higher strength-to-weight ratio. In this context, attention has also been paid to the repair of composite laminates and on the factors influencing the effectiveness of a repair. Tests were conducted measuring the failure loads of laminates repaired either by the scarf technique or by other lap techniques under tensile loading. As will be discussed below, the results obtained from scarf repairs can be readily transferred to assessing the performance of scarf joints between two undamaged components or members.

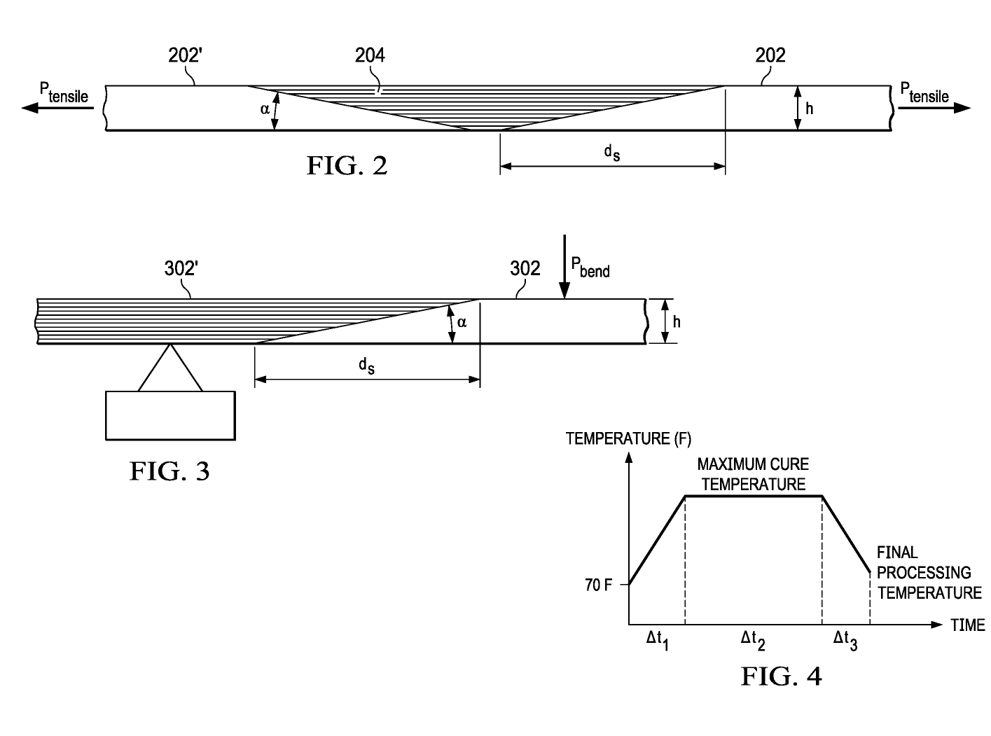

FIG. 2 schematically illustrates an example scarf repair of a damaged laminate 202, 202′ with a scarf repair patch 204. With the scarf repair technique, the repair patch 204 which may be composed of several layers of a resin-impregnated fiber fabric is inserted into the laminate 202, 202′ in place of the material removed due to damage. In the illustrated example, it will be assumed that the laminate has a thickness h and that the individual layers of the repair patch overlap with the laminate 202 over a scarf length dₛ. The scarf angle α is defined as α=atan(h/dₛ). For example, plain weave carbon fiber fabric prepreg plies (3k70 plain weave carbon fiber fabric—with either Hexcel F593, Ciba Geigy R922, or Ciba Geigy R6376 resin system) are exemplary material systems that may be used in the construction of the base laminates. The prepreg plies of the repair material may also be 3k70 plain weave carbon fiber fabric, impregnated with Ciba Geigy M20 resin. These exemplary materials are currently used or being considered for use in several different commercial aircraft. For one exemplary scarf repair with prepreg plies, a layer of film adhesive may be placed between the base laminate and the repair material to facilitate bonding between the base laminate and the repair material. However, using an adhesive with scarf joints is optional when the composite resin system alone is able to provide enough bonding strength. When an adhesive layer is used in the scarf joints, it will act as in-situ lubrication that will promote the deployment of the laminate during the cure.

After the repair material is applied, the repair area is typically vacuum-bagged and cured in an autoclave at elevated temperatures under atmospheric pressure (see FIG. 6). Depending on the resin system used, the maximum cure temperature may vary from room temperature up to a temperature of about 450° F.

The mechanical strength of assemblies repaired or bonded by way of scarf joint may be tested and modeled for several different situations. For example, in one situation illustrated in FIG. 2, scarf joints may be tested under an applied tensile load. In another situation illustrated in FIG. 3, scarf joints may be tested under a bending load. Although not shown explicitly in FIG. 2, the laminates 202, 202′ may have a layered composite structure as well.

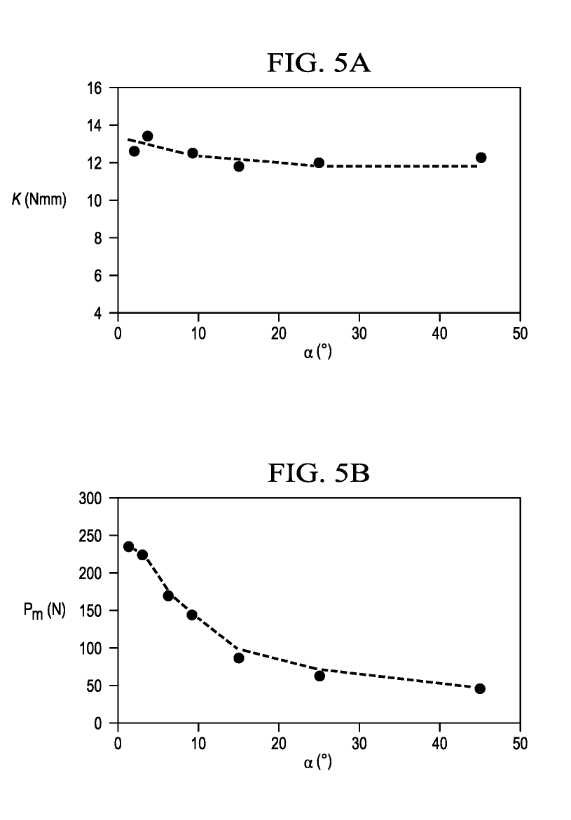

FIG. 3 shows two laminates 302, 302′ joined by a scarf joint. As in FIG. 2, each example laminate has a thickness h, the scarf joint has a length dₛ, so that the scarf angle is again defined as α=atan(h/dₛ). For example, laminate 302′ may be clamped, with the bending force P_{bend} applied to laminate 302. It will be understood that both laminates 302, 302′ may have a layered composite structure. In both situations, the maximum load at which the specimen failed (failure load) was recorded. The failed specimens were also inspected visually to establish the mode of failure. For example, as illustrated in FIG. 5B, it was found that for a scarf repair, the failure load Pₘ gradually decreases with increasing scarf angle. The maximum load failure Pₘ was recorded for bending loads as a function of scarf angles α varying from 2° to 45°. As can be seen from FIG. 5B, the values of Pₘ show an exponential increase with decreasing a. Experimental results for tensile loads (see FIG. 2) are available in the published literature only for scarf angle less than about 2.5°. Based on these results, repairs with scarf angles of less than about α=2° exhibit the greatest mechanical strength under tensile as well as bending loads and almost match the mechanical strength of the undamaged laminate. As can be seen from FIG. 5A, the stiffness K of the scarf joint decreases only insignificantly with increasing scarf angle α. It was also found that repaired areas should be cured at the highest permissible temperature so as to achieve the shortest cure time.

When a composite tube assembly with a hollow cross-section is used, as described above, in tail booms and horizontal stabilizer spars of aircrafts, the scarf joints do not carry major structural loads which act in the direction of the scarf joint, i.e. perpendicular to the longitudinal axis of the tube assembly. As a result, larger scarf angles having a reduced failure load may be employed provided that the scarf joint is able to withstand the larger structural load exerted in the longitudinal direction of the tube assembly. Starting from this premise, it is proposed in the present disclosure to manufacture an elongated high-strength composite part with a hollow cross section from a plurality of sections that are subsequently joined by a scarf joint. The sections may be prepreg, i.e. uncured or not fully cured carbon-reinforced resin parts that are still malleable and can be inserted in a mold and then fully cured therein, as will be described below.

The described scarf joints are designed to transfer 100% of the loads between the segments by shear load transfer only. Scarf joints between the segments with a slope ratio of typically minimum 10:1 (scarf angle α˜6°) and maximum 50:1 (scarf angle α˜1.5°) were constructed. The scarf joints allow uniform stress distribution with maximum efficiency and also allow a wall thickness having a substantially constant cross-section along the scarf joint.

Each separate segment of the composite material may be laminated in a variety of methods to create preforms. It can be laminated over male or female mandrels. It can be laminated flat by hand or by automated machinery and subsequently formed to the required cross-section, optionally using heat (hot drape forming). Some segment can be directly laminated inside the curing tool, typically the lower segment.

If using dry fibers, segment preforms can be made by using a binder product to hold the plies together at the desired cross-section before resin is incorporated. Resin can be added either before (wet layup) or during the cure (RTM or resin infusion).

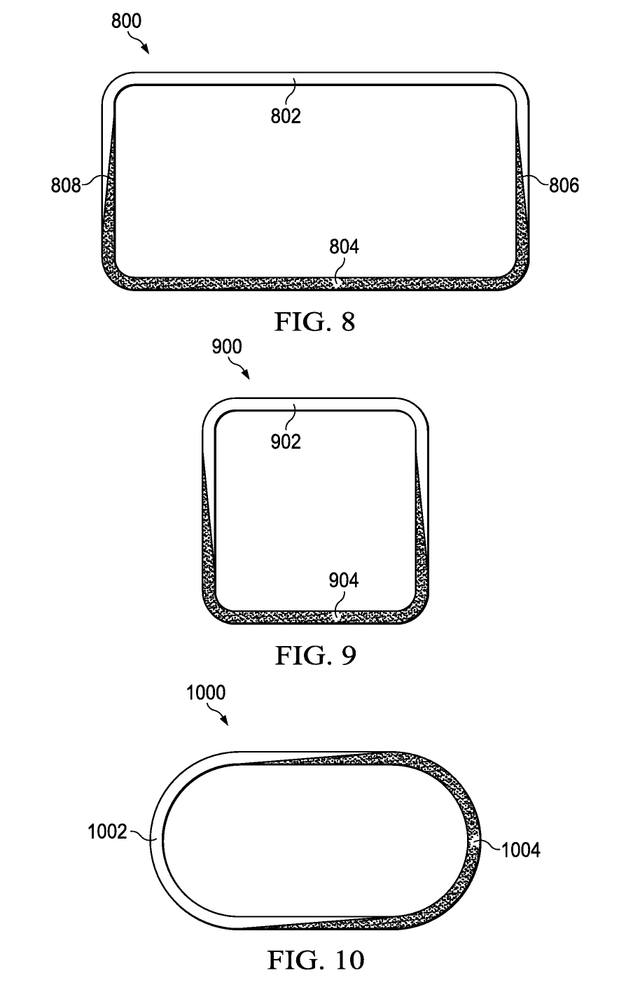

FIG. 6 illustrates schematically in cross section a part curing tool 600 that may be made of two halves 602, 604 that are hinged lengthwise at hinge 606 (clamshell tool). The two halves separate at parting line 608. The part curing tool 600 is closed tight after the composite material segments 702, 704; 802, 804 (see for example FIG. 7 and FIG. 8) and other tooling components (inflatable bladder 610, thermocouples (not shown), etc.) are assembled inside the tool cavity. The inflatable bladder 610 serves to urge and tightly press the exterior surfaces of the composite material segments 702, 704; 802, 804 against the interior walls of the closed part curing tool 600. At this stage of the process, i.e. before the composite material segments 602, 604 and the corresponding scarf joints are cured, the segments 702, 704; 802, 804 are still able to slide against each other, allowing the contour of the segments 702, 704; 802, 804 to conform to the interior wall surfaces of the closed part curing tool 600 without giving rise to voids and creases.

FIG. 7 shows a first embodiment of a segmented composite tube assembly with a square cross section. Two different segments 702, 704 may be prepared as prepreg segments having end sections with matching scarf angles; the segments 702, 704 may be joined at the end sections to form a scarf joint having a substantially uniform thickness. In this example, the lower segment 704 may be inserted into the bottom half 604 of the mold 600, and the upper segment 702 may be placed inside the upper half 602 of the mold 600. The two halves 602, 604 of the mold 600 are then closed and the bladder 610 is inflated to urge the two segments 702, 704 against the inside walls of the respective halves 602, 604 of the mold 600. The composite part is then cured at elevated temperatures, as described above.

FIG. 8 shows a second embodiment of a segmented composite tube assembly with a rectangular cross section. In FIG. 8, the scarf angles are inverted compared to FIG. 7. However, the orientation of the scarfs is optional and will be the result of a combination of factors including assembly sequence, scarf slope, number of segments, etc. For example, in FIG. 8, the upper segment 802 may be inserted into the upper half 602 of the mold 600, and the lower segment 804 may be placed inside the upper half 602 of the mold 600. The lower half 604 of the mold 600 is then closed and the bladder 610 is inflated to urge the segments 802, 804 against the inside walls of the mold 600. The composite part is then cured at elevated temperatures, as described above.

FIG. 9 illustrates a third exemplary embodiment of a segmented composite tube assembly in cross-section. In this embodiment, the cross section is square, as in FIG. 7, but the top section 902 and the bottom section 904 may be constructed identically, wherein each segment has one beveled section with an outwardly facing joining surface and one beveled section with an inwardly facing joining surface, with substantially identical scarf angles. In other words, the bottom section 904 is an inverted top section 902, which reduces the parts count that need to be kept in inventory to assemble the hollow composite tube assembly.

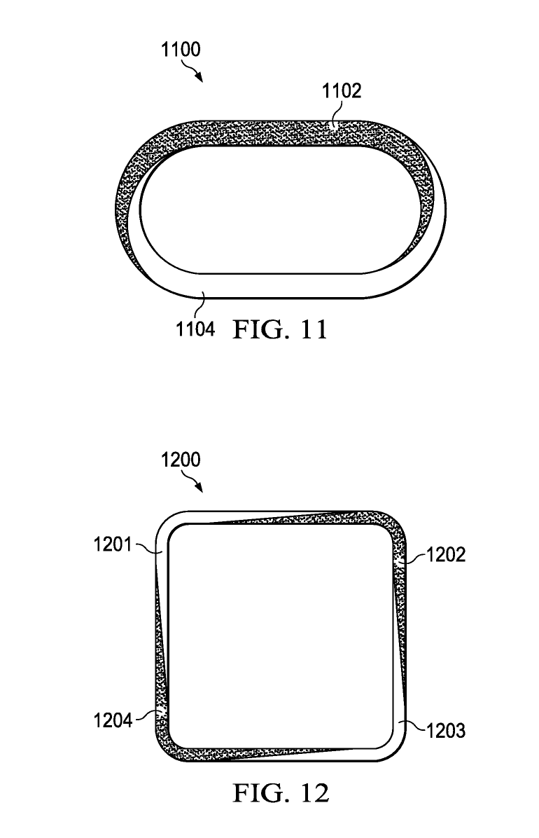

FIG. 10 and FIG. 11 illustrate respective fourth and fifth embodiments, wherein the segmented composite tube assembly 1000 and 1100, respectively, has a substantially oval cross-section and the scarf joints joining the respective segments 1002, 1004; 1102, 1104 have commensurately an arcuate shape. However, the above discussion concerning the scarf angle applies, mutatis mutandis, also to such arcuate scarf joints. The interior surfaces of the tool 600 need to be adapted commensurate with the oval shape of the segmented composite tube assemblies 1000, 1100.

FIG. 12 illustrates a sixth embodiment, wherein the segmented composite tube assembly 1200 has a substantially square cross-section and is composed of four segments 1201, 1202, 1203, 1204 which may be constructed identically, similar to the two identical segments of the embodiment of FIG. 9. Each segment 1201, 1202, 1203, 1204 has one beveled section with an outwardly facing joining surface and one beveled section with an inwardly facing joining surface, with substantially identical scarf angles. This reduces the parts count that need to be kept in inventory to assemble the hollow composite tube assembly.

Blind fasteners may optionally be additionally installed through the scarf joints to provide load transfer redundancy for certification reasons.

A vacuum can optionally be applied on the exterior of the tool to evacuate any air or volatiles trapped between the outside surface of the segments and the interior tool surface.

The diagrams in the FIGURES illustrate the architecture, functionality, and operation of possible implementations of various embodiments of the present disclosure. Although several embodiments have been illustrated and described in detail, numerous other changes, substitutions, variations, alterations, and/or modifications are possible without departing from the spirit and scope of the present invention, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted.

Although certain embodiments have been described with reference to a rotorcraft, the embodiments are not limited to rotorcrafts but may also be used on aircrafts or cars, or any other type of apparatus or device that uses control surfaces.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

What is claimed is:

1. A hollow tube assembly, comprising:
a plurality of concave segments each extending in a longitudinal direction of the hollow tube assembly and having tapered edges, wherein different ones of the concave segments are joined along the tapered edges by scarf joints to form the hollow tube assembly.

2. The hollow tube assembly of claim 1, wherein each of the scarf joints has an overall thickness that is substantially equal to a thickness of the concave segments.

3. The hollow tube assembly of claim 1, wherein each of the tapered edges has a taper angle of less than 6 degrees.

4. The hollow tube assembly of claim 3, wherein each of the tapered edges has a taper angle of less than 3 degrees.

5. The hollow tube assembly of claim 1, wherein each of the concave segments is constructed from a layered composite material comprising a material selected from one or more structural fibers in combination with a plastic resin.

6. The hollow tube assembly of claim 5, wherein the structural fibers comprise carbon fiber reinforced polymers (CFRP).

7. The hollow tube assembly of claim 5, wherein the layered composite material is pre-impregnated with resin (prepreg).

8. The hollow tube assembly of claim 6, wherein each of the tapered edges is formed by superimposing CFRP layers with a relative offset perpendicular to the longitudinal direction.

9. The hollow tube assembly of claim 1, wherein each of the scarf joints is formed without application of an interposed adhesive.

10. The hollow tube assembly of claim 1, wherein each of the scarf joints is formed with an interposed adhesive.

11. The hollow tube assembly of claim 1, wherein each of scarf joints has an arcuate shape.

12. A method for forming a hollow tube assembly from a plurality of concave segments extending in a longitudinal direction of the hollow tube assembly, comprising:
forming at least one first concave segment extending in the longitudinal direction and having first tapered edges;
forming at least one second concave segment extending in the longitudinal direction and having second tapered edges; and
forming the hollow tube assembly by joining the at least one first concave segment and the at least one second concave segment along the respective first and second tapered edges by a scarf joint.

13. The method of claim 12, wherein the at least one first concave segment and the at least one second concave segment are joined by:
placing the at least one first concave segment and the at least one second concave segment inside a mold; and
urging the at least one first and second concave segments against inside surfaces of the mold.

14. The method of claim 13 further comprising curing the at least one first and second concave segments with the scarf joint inside the mold at elevated temperatures.

15. The method of claim 13, wherein the first and second tapered edges of the scarf joint are capable of moving against one another before being cured inside the mold.

16. The method of claim 12, wherein the first and second tapered edges have taper angles of less than 6 degrees.

17. The method of claim 12, wherein the first and second tapered edges have taper angles of less than 3 degrees.

18. The method of claim 12, wherein the concave segments are constructed from a composite material comprising resin-impregnated carbon fiber reinforced polymers (CFRP).

19. The method of claim 18, wherein the first and second tapered edges are formed by superimposing layers of the resin-impregnated CFRP with a relative offset perpendicular to the longitudinal direction.

20. An airframe component constructed to carry structural loads, comprising a hollow tube assembly constructed from a plurality of concave segments made of a layered fiber-reinforced composite material, with the concave segments extending in a longitudinal direction of the hollow tube assembly and having tapered edges, wherein different of the plurality of concave segments are joined along the tapered edges by scarf joints having a scarf angle of less than 6 degrees.
